(19) United States
(12) Patent Application Publication
(10) Pub. No.: US 2016/0352974 A1
(43) Pub. Date: Dec. 1, 2016

(54) Using Comparative Pixel and Luminance Adjustment for Creating a Varying Acuity Perception

(71) Applicant: Allan N. Hytowitz, Alpharetta, GA (US)

(72) Inventor: Allan N. Hytowitz, Alpharetta, GA (US)

(73) Assignee: Allan N. Hytowitz, Alpharetta, GA (US)

(21) Appl. No.: 14/722,816

(22) Filed: May 27, 2015

(51) Int. Cl. H04N 1/60; G06T 5/00; G06T 7/00

(52) U.S. Cl. CPC H04N 1/6027; G06T 7/0075; G06T 5/001

(57) ABSTRACT

Acuity is a function of the photoreceptors of the eye which combine their pixelized stimulation to create the perception of a contiguous image. The image perception is determined by the intensity of the light as a stimulus absorbed by those pixels and, for most individuals, the color frequency of that light. That image clarity is also a function of the density of the photoreceptors as recipients of that pixelized stimulation. Distance perception by the eye is enhanced by the relative clarity of the image, intensity or brightness of the image, and the relative size of the image in that when two similar images are in the same field of view, the larger of the images is perceived as being closer.

Electronic displays emulate that photoreceptor stimulation with pixels that emit light such that the pixels density, when observed from a sufficient distance, gives the viewer the perception that the image is contiguous. As the pixel density increases, and the image becomes brighter, the image seems to become clearer to the viewer.

By modulating the intensity and pixilation of portions of an image in relationship to other portions such that one image has a lower pixilation and lower image intensity versus another image superimposed on that less pixelized image, it is possible to have those relative images appear to be in 3D such that they are perceived as being viewed at different distances.

### BACKGROUND

The eye as an optical system is a primary organ of the body for determining location and orientation. The primary components within the eye for responding to that stimulus of light are the photoreceptors. Rod photoreceptors are primarily responsive to the intensity of light. Cone photoreceptors are primarily sensitive to specific frequency ranges of light such as red (L-long), green (M-medium), and blue (S-short). Red (L) photoreceptors tend to have a primary sensitivity to light from 440 nm up to 680 nm with a peak at 564 nm. Green (M) photoreceptors tend to have a primary sensitivity to light from 440 nm up to 640 nm with a peak at 534 nm. Blue (S) photoreceptors tend to have a primary sensitivity to light from 360 nm up to 500 nm with a peak at 420 nm.

As light passes through the lens of the eye, its focus is modulated by the stress of the muscles and cilia attached to it. That focal process also has a chromatic effect inherent in lenses due to frequencies of light being refracted (bent) by the lens at different angles reflective of, and proportional to, that optical frequency. That chromatic refraction not only results in the focus of light, but also results in those frequencies being focused at different sequential depths within the retina based upon that wavelength frequency. With a convex-type lens such as what is typically found in the eye, Blue (S) light is focused at a shorter distance than green (M) light which is focused on a shorter distance than red (L) light. The point of optimum focus for an image is the acuity endpoint.

The current perspective of acuity is based upon the creation of images with a uniform intensity and pixilation for a reflected light, scattered light, and emitted light images. Emitted light images, however, allow for area specific modulation of the pixel density, luminance, and color. As such, what may appear to be an identical emitted light image as to shape and angular width may me modulated as to pixel density, luminance, and spectral color.

Calibration of the apparent acuity of disparate areas of an image may be determined by use of a dynamic optotype whose calibrated angular arc width, angular rotation/motion speed, rotation direction, segments, gaps, color, background contrast, and stroke-width thickness and incidence of the segment and gaps may be used to determine visual acuity.

### Application

Emitted light images, having an identical shape and angular width, but with a higher pixel density and higher luminance, appear to be clearer and have a higher (further value for the) acuity endpoint. As the pixel density is decreased and the luminance is reduced, the acuity endpoint for the image is reduced. Further reduction of the pixel density and luminance further reduces the acuity endpoint. An adjacent comparison of images with disparate levels of pixel density and luminance will result in image areas of higher pixel density and luminance appearing to be closer than image areas with lower pixel density and lower luminance, and even closer than with image areas with still lower pixel density and lower luminance.

The apparent visual effect is that the higher pixel density and higher luminance areas will not only appear to be closer, but will create an apparent simulated 3 dimensional effect for the entire image area, even though the actual image is on a 2 dimensional surface.

### BRIEF DESCRIPTION OF THE SEVERAL VIEWS OF THE DIAGRAMS

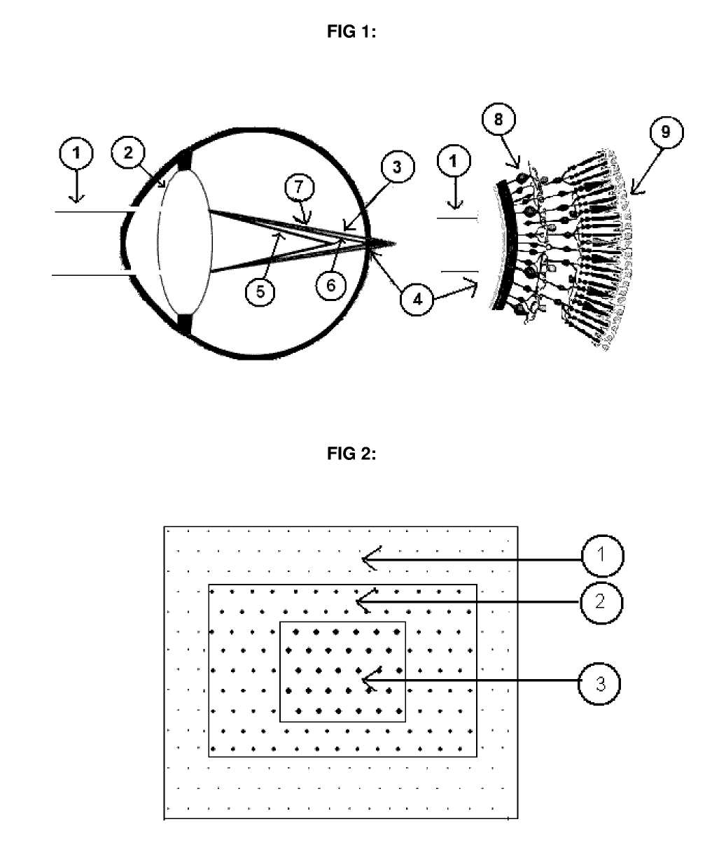

FIG. 1: Chromatic focal regulation for a biological eye

Item 1—Rays of light

Item 2—Lens of the eye

Item 3—Chromatic separation of light intensity on the retina with red at the furthest focal length behind the retina, green focused on the retina, and blue in front of the retina with a convex lens.

Item 4—Fovea location for chromatic sensitive photoreceptors.

Item 5—S—Blue—short wavelength of light

Item 6—M—Green—medium wavelength of light

Item 7—L—Red—long wavelength of light

Item 8—Layers of neural ganglia for signal processing

Item 9—Array of S-M-L photoreceptors

FIG. 2: Schematic for a simulated positive apparent image

Item 1—Lower pixel intensity and lower luminance image area

Item 2—Medium pixel intensity and medium luminance image area

Item 3—Higher pixel intensity and higher luminance image area

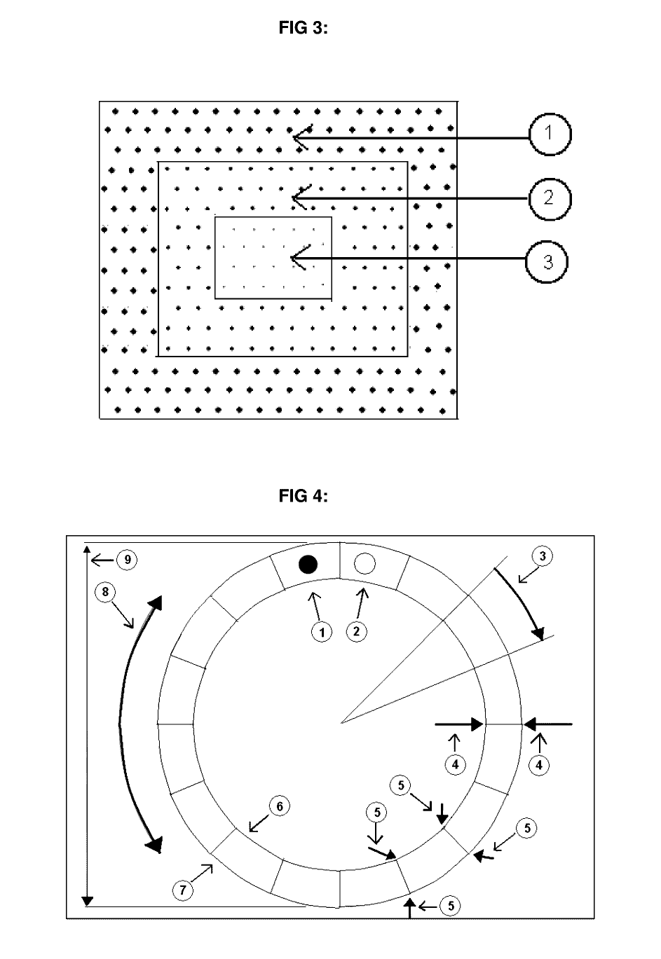

FIG. 3: Schematic for a simulated negative apparent image

Item 1—Higher pixel intensity and higher luminance image area

Item 2—Medium pixel intensity and medium luminance image area

Item 3—Lower pixel intensity and lower luminance image area

FIG. 4: Rotating dynamic optotype components

Item 1—first alternating segment color.

Item 2—second alternating segment color

Item 3—segment angular width (degrees)

Item 4—arc segment width as % of total optotype diameter

Item 5—arc segment area in arc seconds squared

Item 6—inner segment diameter

Item 7—outer segment diameter

Item 8—rotational/motion velocity in revolutions per minute

Item 9—total visual angle in arc minutes

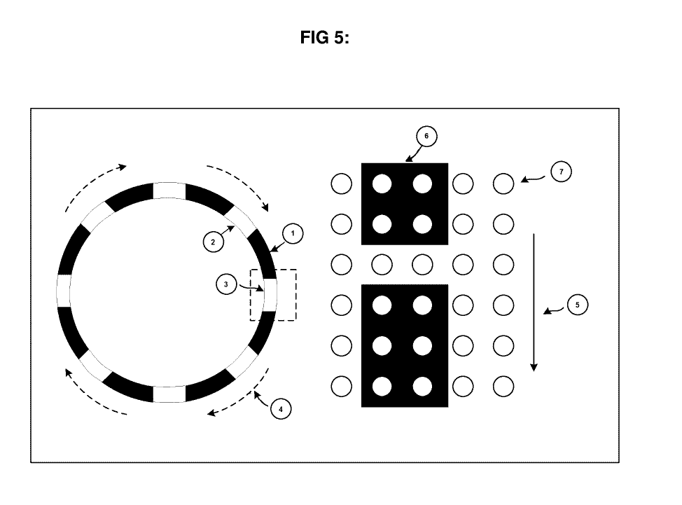

FIG. 5: Rotating dynamic optotype stimulus path effect

Item 1—first alternating segment color.

Item 2—second alternating segment color

Item 3—arc segment area in arc seconds squared

Item 4—rotational/motion direction as clockwise or counterclockwise

Item 5—rotational/motion velocity in revolutions per minute

Item 6—representation path of image gap across the photoreceptors

Item 7—representation of photoreceptor distribution

What is claimed is:

1. The modulation of the apparent pixel density of portions of an image, the modulation of the relative apparent brightness of portions of that image, and the modulation of the apparent spectral frequency of portions of that image can be used to create the apparent perception of a three dimensional image when those disparate images areas are viewed in adjacent areas on a two dimensional surface.

2. The modulation of a dynamic optotype, whose calibrated angular arc width, angular rotation/motion speed, rotation direction, segments, gaps, color, background contrast, and stroke-width thickness and incidence of the segment and gaps as used to determine visual acuity, can be used to quantify differences in the apparent acuity endpoint of the perception of a three dimensional image when those disparate image areas are viewed in adjacent areas on a two dimensional surface.
